(19) United States
(12) Patent Application Publication
(10) Pub. No.: US 2005/0145755 A1
(43) Pub. Date: Jul. 7, 2005

(54) Optical cable stopper

(75) Inventor: Hayato Yuuki, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEM, LTD., Yokkaichi-shi (JP); SUMITOMO ELECTRIC INDUSTRIES, LTD., Osaka-shi (JP)

(21) Appl. No.: 10/959,128

(22) Filed: Oct. 7, 2004

(30) Foreign Application Priority Data
Oct. 7, 2003 (JP) 2003-347820

(51) Int. Cl. G02B 6/00

(52) U.S. Cl. 248/49; 385/136

(57) ABSTRACT

An optical cable stopper includes a plurality of cut-in portions that cut side portions of a cover portion of an optical cable, a plurality of side guide portions that guide the cut-in portions by being brought into sliding contact with the side portions of the cover portion such that the cut-in portions do not cut respective fiber core lines when cutting the side portions of the cover portion, and a center guide portion that guides the cut-in portions by being guided to insert into a guide groove provided in the cover portion such that the cut-in portions do not cut the respective fiber core lines when cutting the side portions of the cover portion.

The disclosure of Japanese Patent Application No. JP2003-347820 is incorporated herein by reference in its entirety.

### BACKGROUND OF THE INVENTION

1. Field of Invention

The present invention relates to a technology of fixing an optical cable used as a signal transmitting part, and is particularly useful in, for example, a vehicular optical communication system or the like.

2. Description of Related Art

As a technology of fixing an optical cable to an optical connector or an optical plug, particularly an optical cable fixing technology applied to use of an automobile, the mainstream is a technology of calking a ring-like member made of a metal to an optical cable. There is also a technology of causing a metal piece in a U-like shape to bite into a cover portion of an optical cable, a technology of welding to bond an optical cable fixing part and an optical cable cover by using laser welding, and the like.

A technology of fixing an optical cable is disclosed in, for example, JP-A-2001-235654 or the like.

### SUMMARY OF THE INVENTION

However, in using an optical cable in a vehicle, in installing or using the optical cable, there is a concern of exerting a sudden external force to the optical cable. Therefore, in fixing an optical cable, there is needed a sufficient strength capable of withstanding such a sudden external force.

Further, in fixing an optical cable, there is needed some operation to a cover portion of the optical cable, such as calking a ring-like part to the cover portion, or causing a metal piece in a U-like shape to bite into the cover portion. At this occasion, when a flaw or the like is adhered to a fiber core line of the optical cable, an increase in optical loss is brought about. Particularly, when the cover portion is make to have a thin wall for achieving light-weight-ness and compact-ness of the optical cable, a flaw is liable to be attached to a fiber core line at a portion of fixing the optical cable.

Hence, it is an object of the invention to provide a technology capable of solidly fixing an optical cable while reducing the occurrence of flaws being adhered to a fiber core line.

In order to achieve the above-described object, in exemplary embodiments, the invention provides an optical cable stopper that fixes an optical cable that includes a cover portion surrounding a plurality of fiber core lines arranged in parallel with each other at a predetermined interval therebetween, and includes a guide groove provided at an outer periphery of the cover portion along a longitudinal direction of the fiber core line at a position between two of the fiber core lines. The optical cable stopper includes a plurality of cut-in portions that cut side portions of the cover portion, a plurality of side guide portions that guide the cut-in portions by being brought into sliding contact with the side portions of the cover portion such that the cut-in portions do not cut the respective fiber core lines when cutting the side portions of the cover portion, and a center guide portion that guides the cut-in portions by being guided into the guide groove provided at the outer periphery of the cover portion and between the plurality of fiber core lines such that the cut-in portions do not cut the respective fiber core lines when cutting the side portions of the cover portion.

According to this structure, by bringing the side guide portions into sliding contact with the side portions of the cover portion and guiding the center guide portion into the guide groove of the cover portion, the cut-in portions are guided to cut the side portions of the cover portion without cutting the respective fiber core lines, and therefore, the optical cable can be reliably fixed while reducing the occurrence of flaws being adhered to the fiber core line.

In exemplary embodiments, the invention provides an optical cable stopper that fixes an optical cable covered with a cover portion at a periphery of a fiber core line, the optical cable stopper including a plurality of cut-in portions that cut side portions of the cover portion, and a plurality of side guide portions that guide the cut-in portions by being brought into sliding contact with the side portions of the cover portion such that the cut-in portions do not cut the respective fiber core lines when cutting the side portions of the cover portion.

According to this structure, by bringing the side guide portions into sliding contact with the side portions of the cover portion, the cut-in portions are guided to cut the side portions of the cover portion without cutting the respective fiber core lines, and therefore, the optical cable can more reliably be fixed while reducing the occurrence of flaws being adhered to the fiber core line.

In this case, the side guide portions may include first guide portions extended along distal end sides of the cut-in portions and guide the cut-in portions by being brought into sliding contact with the side portions of the cover portion before the cut-in portions cut the cover portion. According to this structure, the cut-in portions are guided by the first guide portions before cutting the cover portion, and therefore, the optical cable can be fixed more reliably while more reliably reducing the occurrence of flaws being adhered to the fiber core line.

In exemplary embodiments, the side guide portions may include second guide portions arranged along the cut-in portions for guiding the cut-in portions by being brought into sliding contact with the side portions of the cover portion in the midst of cutting of the cover portion by of cut-in portions. According to this structure, the cut-in portions are guided by the second guide portions even in the midst of cutting the cover portion, and therefore, the occurrence of flaws being adhered to the fiber core line can be even more reliably reduced.

In exemplary embodiments, the invention provides an optical cable stopper that fixes an optical cable including a cover portion surrounding a plurality of fiber core lines arranged in parallel with each other at a predetermined interval therebetween, and including a guide groove provided at an outer periphery of the cover portion along a longitudinal direction of the fiber core lines at a position between two of the fiber core lines. The optical cable stopper includes a plurality of cut-in portions that cut side portions of the cover portion, and a center guide portion that guides the cut-in portions by being guided into the guide groove at the outer periphery of the cover portion and between the plurality of fiber core lines such that the cut-in portions do not cut the respective fiber core lines when cutting the side portions of the cover portion.

According to this structure, by guiding the center guide portion into the guide groove of the cover portion, the cut-in portions are guided to cut the side portions of the cover portion without cutting the respective fiber core lines, and therefore, the optical cable can be fixed more reliably while reducing the occurrence of flaws being adhered to the fiber core line.

In this case, the center guide portion may guide the cut-in portions by being guided into the guide groove before cutting the cover portion by the cut-in portions. According to this structure, the center guide portion is inserted to guide into the guide groove before cutting of the cover portion by the cut-in portions to guide the cut-in portions, and therefore, the occurrence of flaws being adhered to the fiber core line can be even more reliably reduced.

In exemplary embodiments, the center guide portion may guide the cut-in portions by piercing the cover portion between the plurality of fiber core lines from a bottom portion of the guide groove in the midst of cutting of the cover portion by the cut-in portions. According to this structure, the center guide portion guides the cut-in portions by piercing the cover portion between the plurality of fiber core lines from the bottom portion of the guide groove in the midst of cutting of the cover potion by the cut-in portions, and therefore, the occurrence of flaws being adhered to the fiber core line can be even more reliably reduced.

In exemplary embodiments, a distal end portion of the center guide portion may have a shape, a dimension of which successively reduces in a distal end direction at least in a width direction of the optical cable. According to this structure, the cut-in portions can more reliably be guided to a position at which the cut-in portions do not cut the core line and therefore, the occurrence of flaws being adhered to the fiber core line can be even more reliably reduced.

These and other objects, advantages and salient features of the invention are described in or apparent from the following description of exemplary embodiments.

### BRIEF DESCRIPTION OF THE DRAWINGS

Exemplary embodiments of the invention will be described in connection with the drawings, wherein like numerals represent like parts, and wherein:

FIG. 1 is a view showing an example of applying an optical cable stopper;

FIG. 2 is a perspective view of the optical cable stopper of FIG. 1;

FIG. 3 is a front view of the optical cable stopper of FIG. 1; and

FIG. 4A through FIG. 4C are views for explaining states of fixing an optical cable by using the optical cable stopper of FIG. 1.

### DETAILED DESCRIPTION OF PREFERRED EMBODIMENTS

An explanation will be given of an optical cable stopper according to an embodiment of the invention as follows.

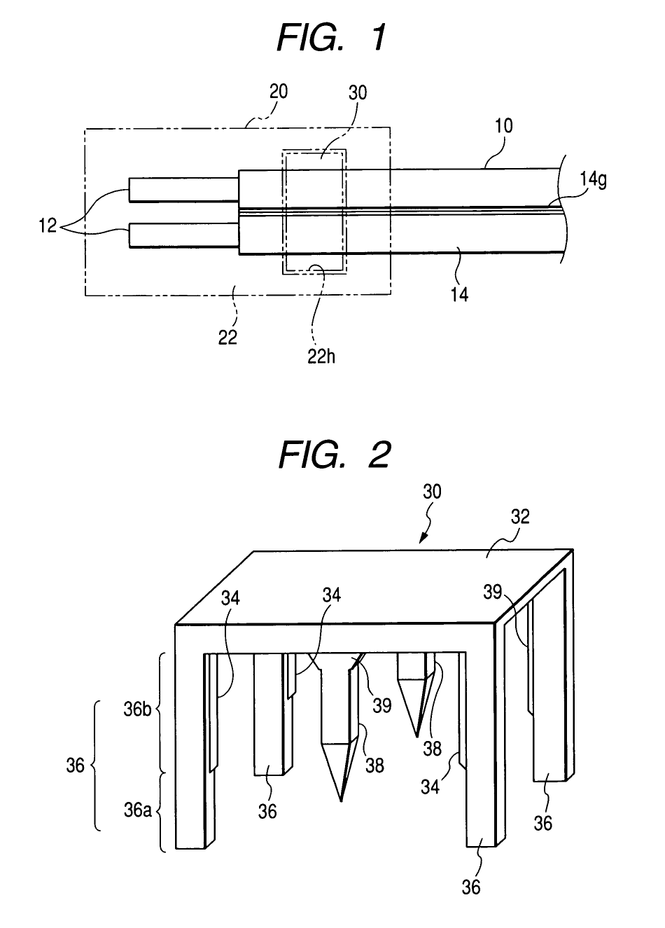

FIG. 1 is a view showing an example of applying an optical cable stopper. In the drawing, an example of fixing an optical cable to an optical connector is shown.

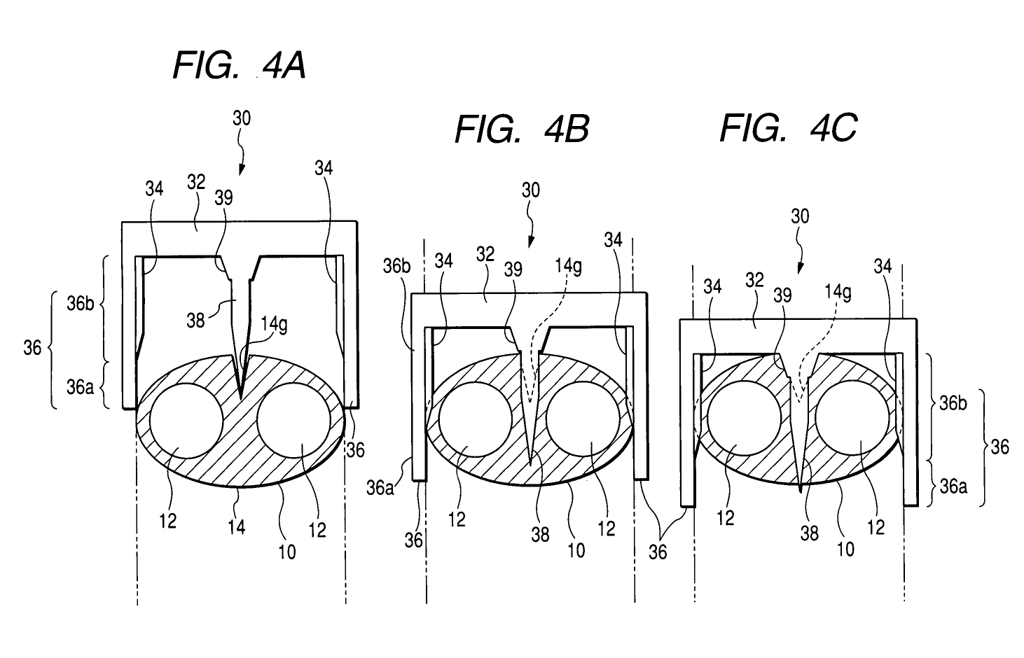

An optical cable 10 includes a cover portion 14 that surrounds two pieces of fiber core line 12 arranged in parallel with each other with a predetermined interval therebetween. A sectional shape of the optical cable 10 may be substantially elliptical (refer to FIG. 4A), or any other suitable shape such as, for example, substantially rectangular. Further, although according to the depicted embodiment, an explanation will be given of an example of including two pieces of the fiber core lines 12, there may be constructed a structure including three pieces or more of the fiber core line 12. Further, with regard to a structure of a pair of side guide portions 36, mentioned later, the structure is applicable even to an optical cable including one piece of the fiber core line 12.

Further, a guide groove 14g in, for example, a substantially V-like shape extended along a longitudinal direction of the optical cable 10 is provided at an outer periphery of the optical cable 10, at a location between the respective fiber core lines 12 (refer to FIG. 1 and FIG. 4A). A single guide groove 14g may be provided at the periphery of the optical cable 10. Alternatively, two guide grooves 14g may be provided at, for example, positions opposed to each other. Incidentally, by providing only a single guide groove 14g at the outer periphery of the optical cable 10, two fiber core lines 12 can be discriminated from each other by using the guide groove 14g as a reference. Thereby, for example, there is achieved an advantage of being able to discriminate either of the fiber core lines 12 for transmission or for reception at an arbitrary position of the optical cable 10.

Further, an optical connector 20 includes a holding hole (not illustrated) capable of receiving fiber core lines 12 that are exposed at a front end portion of the optical cable 10, as well as a portion of the cover portion 14 of the optical cable 10 rearward from the exposed portion of the fiber core lines 12, inside of a housing 22 formed by a resin or the like. The optical cable 10 and the pair of fiber core lines 12 exposed at the front end portion are inserted into the holding hole.

Further, a stopper mounting hole 22h is provided at a position of the housing 22 wherein is received the cover portion 14 of the optical cable 10. Further, a stopper 30 is fitted into the stopper mounting hole 22h to cause the stopper 30 to bite into the cover portion 14. Thereby, the optical cable 10 is fixed at a predetermined portion inside the housing 22.

The fiber core lines 12 fixed by the optical connector 20 as described above are optically coupled to, for example, a light emitting element or a light receiving element held separately with respect to the optical connector 20. Further, by connecting the optical connector 20 and mating optical connector (not shown), the fiber core lines 12 and fiber core lines or an optical device associated with the mating optical connector are optically coupled.

The optical cable stopper 30 explained here is applicable also to a case of fixing an optical cable directly to an optical plug or an electronic apparatus.

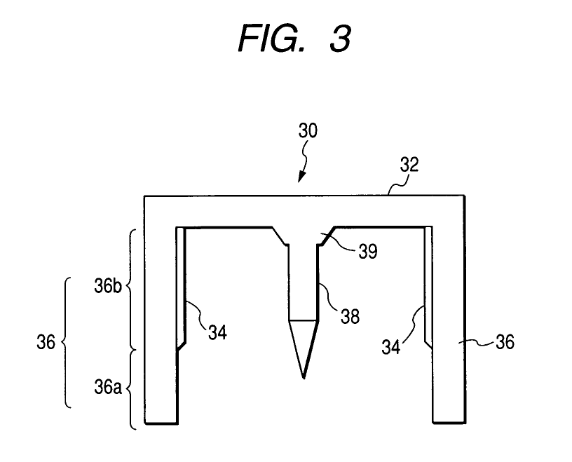

FIG. 2 is a perspective view showing the optical cable stopper 30 and FIG. 3 is a front view showing the optical cable stopper 30.

The optical cable stopper 30 may be a member formed by a resin or the like and may be provided with a base portion 32, pairs of cut-in portions 34 respectively provided at a front end portion and a rear end portion of the base portion 32, opposing pairs of side guide portions 36, and center guide portions 38.

The base portion 32 supports the cut-in portions 34, the side guide portions 36 and the center guide portions 38 and may be provided substantially in a shape of, for example, a substantially square or rectangular plate.

The pairs of side guide portions 36 are formed at respective end portions of the base portion 32. Each of the side guide portions 36 is formed substantially in a shape of a prism extended from the base portion 32 in a predetermined direction substantially orthogonal to a plane including the base portion 32, that is, in a downward direction from the base portion 32 in FIG. 2 and FIG. 3. A dimension between each pair of side guide portions 36 is preferably set to be substantially the same as a width dimension of the optical cable 10 (a width direction in a direction of parallelly aligning the fiber core lines 12). Further, there is provided a structure in which the optical cable 10 is movable along a longitudinal direction of each of the side guide portions 36 while bringing both side portions of the cover portion 14 of the optical cable 10 and inner faces of the pair of side guide portions 36 into sliding contact with each other.

Further, the inner faces of the pair of side guide portions 36 are provided with the cut-in portions 34. Each of the cut-in portions 34 may be formed in a shape of a slender plate extended along a line substantially at a center, in a width direction, of the inner face of each of the side guide portions 36. Further, each of the cut-in portions 34 preferably extends from a base end portion of each of the side guide portions 36 to a position slightly past the longitudinal center of the respective side guide portion 36. Further, when the optical cable 10 is moved relatively to a side of the base portion 32 along the longitudinal direction of the respective side guide portions 36 while bringing both the side portions of the cover portion 14 of the optical cable 10 and the inner faces of the pair of side guide portions 36 into sliding contact, the pair of cut-in portions 34 cut into the side portions of the cover portion 14 due to the relative movement.

Further, the cut-in portions 34 may be provided with a blade, that cuts the cover portion 14, in a shape of a knife, that is, a shape in which a tip of the blade lies along the cutting direction. Alternatively, the blade may cut the cover portion 14 in a shape of a flat chisel, that is, the tip of the blade may lie along a direction substantially orthogonal to the cutting direction.

The side guide portions 36 include first guide portions 36a that are brought into sliding contact with the side portions of the cover portion 14 before the cut-in portions 34 cut the side portions of the cover portion 14.

The side guide portions 36 also include second guide portions 36b, which are arranged along the respective cut-in portions 34. The second guide portions 36b are brought into sliding contact with the side portions of the cover portion 14 when the cut-in portions 34 cut the side portions of the cover portion 14.

Further, a single center guide portion 38 is provided substantially at a center portion of the front end portion of the base portion 32, and another single center guide portion 38 is provided substantially at a center portion of the rear end portion of the base portion 32.

The center guide portions 38 may be formed in a shape of a column extended from substantially the center portion of the front end portion and rear end portion, respectively, of the base portion 32 in a direction substantially the same as that of the respective side guide portions 36, that is, downward from the base portion 32.

A distal end portion of each center guide portion 38 is preferably narrowed successively in a distal end direction, and the distal end portion has a sharpened distal end capable of piercing the cover portion 14. Further, the distal end portion of the center guide portion 38 may be formed in a shape in which the distal end portion is sharpened by successively reducing a dimension thereof in the distal end direction at least in the width direction of the optical cable 10.

The center guide portions 38 preferably have a length such that, in a state before the first guide portions 36a of the pair of side guide portions 36 are brought into sliding contact with the side portions of the cover portion 14 and the pair of cut-in portions 34 cut the cover portion 14, the distal end of the center guide portion 38 reaches a bottommost portion of the guide groove 14g to pierce the cover portion 14.

Further, a base end portion 39 of the center guide portions 38 is formed in a shape in which the width dimension is increased successively toward a base end side thereof.

An explanation will be given of an exemplary operation of fixing the optical cable 10 by using the optical cable stopper 30 constituted as described above.

First, as shown in FIG. 4A, the distal end of the center guide portion 38 is inserted to a bottom of the guide groove 14g of the cover portion 14. At this occasion, by bringing the distal end portion of the center guide portion 38 into sliding contact with a groove face in a V-like shape of the guide groove 14g, the center guide portion 38 is guided to substantially a center, in the width direction, of the guide groove 14g, that is, substantially the center, in the width direction, of the optical cable 10.

Further, when the distal end portion of the center guide portion 38 reaches the bottommost portion of the guide groove 14g, inner faces of the distal end portions of the side guide portions 36 (inner faces of front end portions of the first guide portions 36a) start to be brought into sliding contact with the side portions of the cover portion 14.

Further, when the optical cable stopper 30 is pushed toward the optical cable 10, the distal end portion of the center guide portion 38 pierces from the bottommost portion of the guide groove 14g into the cover portion 14, and the cut-in portions 34 are guided toward a position at which they will cut into the side portions of the cover portion 14 at predetermined positions while bringing the inner faces of the first guide portions 36a of the side guide portions 36 into sliding contact with the side portions of the cover portion 14.

Subsequently, as shown in FIG. 4B, the cut-in portions 34 reach the side portions of the cover portion 14 and cut into the side portions of the cover portion 14. Even in the midst of cutting the side portions of the cover portion 14 by the cut-in portions 34 in this way, the distal end portion of the center guide portion 38 pierces from the bottommost portion of the guide groove 14g into the cover portion 14, and the inner faces of the second guide portions 36b of the side guide portions 36 are brought into sliding contact with the side portions of the cover portion 14. Therefore, even in the midst of cutting the side portions of the cover portion 14 by the cut-in portions 34, the cut-in portions 34 are guided to cut only the cover portion 14 without cutting the respective fiber core lines 12.

Finally, as shown in FIG. 4C, by pushing the optical cable stopper 30 toward the optical cable 10 until a lower face of the base portion 32 is brought into contact with an upper face of the cover portion 14, the optical cable 10 is fixed by using the optical cable stopper 30. Further, even at such a final stage, by bringing the two outer side faces of the base end portion 39 of the center guide portion 38 into sliding contact with the substantially V-shaped inner face of the guide groove 14g, the optical cable 10 is guided such that the center guide portion 38 pierces the cover portion 14 at a proper position, and such that the cut-in portions 34 cut the cover portion 14 at proper positions.

According to the optical cable stopper 30 constituted as described above, by bringing the side guide portions 36 into sliding contact with the side portions of the cover portion 14 and guiding the center guide portion 38 into the guide groove 14g of the cover portion 14, the cut-in portions 34 are guided to cut only the side portions of the cover portion 14 by uniform cut-in widths without cutting the respective fiber core lines 12. Therefore, the optical cable 10 can be solidly fixed while reducing the occurrence of flaws being adhered to the fiber core lines 12.

More specifically, the side guide portions 36 include the first guide portions 36a that are brought into sliding contact with the side portions of the cover portion 14 before the cut-in portions 34 cut the cover portion 14, and therefore, the pair of cut-in portions 34 can be guided to the proper positions to cut only the cover portion 14 before the cut-in portions 34 cut the side portions of the cover portion 14.

Further, the side guide portions 36 include the second guide portions 36b that are brought into sliding contact with the side portions of the cover portion 14 in the midst of cutting the cover portion 14 by the cut-in portions 34, and therefore, even in the midst of cutting the side portions of the cover portion 14 by the cut-in portions 34, the cut-in portions 34 can be guided to the proper positions to cut only the cover portion 14.

Therefore, the optical cable 10 can be even more solidly fixed while even more reliably reducing the occurrence of flaws being adhered to the fiber core lines 12.

Further, the center guide portions 38 are guided into the guide groove 14g before cutting of the cover portion 14 by the cut-in portions 34, and therefore, the cut-in portions 34 can be guided to the proper positions to cut only the cover portion 14, before the cut-in portions 34 actually cut the side portions of the cover portion 14.

Further, the center guide portions 38 guide the cut-in portions 34 by piercing the cover portion 14 between the plurality of fiber core lines 12, beginning from the bottom portion of the guide groove 14g, in the midst of cutting of the cover portion 14 by the cut-in portions 34, and therefore, the cut-in portions 34 can be guided to the proper positions to cut only the cover portion 14 even in the midst of cutting of the side portions of the cover portion 14 by the cut-in portions 34.

Further, the distal end portions of the center guide portions 38 are provided with a shape that successively narrows in the distal end direction at least in the width direction of the optical cable 10, and therefore, the center guide portions 38 can accurately be guided to a predetermined position between the fiber core lines 12, and therefore, the occurrence of flaws adhering to the fiber core lines can be reduced even more reliably.

As an alternative to the above-described structure, only one of the side guide portions 36 and the center guide portions 38 may be provided. That is, a structure may be provided in which only the side guide portions 36 are present, with no center guide portions being present, or vice versa. Further, the side guide portions 36 may be provided with only one of the first guide portions 36a and the second guide portions 36b. That is, the side guide portions may be entirely shaped like the first guide portions 36a, or may be entirely shaped like the second guide portions 36b.

While the invention has been described with reference to specific embodiments, these embodiments should be viewed as illustrative and not limiting. Various modifications, improvements and/or substitutes are possible within the spirit and scope of the invention.

1. An optical cable stopper that fixes an optical cable including a cover portion surrounding a plurality of fiber core lines arranged in parallel with each other at a predetermined interval therebetween, and including a guide groove provided at an outer periphery of the cover portion along a longitudinal direction of the fiber core line at a position between two of the fiber core lines, said optical cable stopper comprising:
a plurality of cut-in portions that cut side portions of the cover portion;
a plurality of side guide portions that guide the cut-in portions by being brought into sliding contact with the side portions of the cover portion such that the cut-in portions do not cut the respective fiber core lines when cutting the side portions of the cover portion; and
a center guide portion that guides the cut-in portions by being guided into the guide groove provided at the outer periphery of the cover portion and between the plurality of fiber core lines such that the cut-in portions do not cut the respective fiber core lines when cutting the side portions of the cover portion.

2. The optical cable stopper according to claim 1, wherein the side guide portions include first guide portions extended along distal end sides of the cut-in portions and guide the cut-in portions by being brought into sliding contact with the side portions of the cover portion before the cut-in portions cut the cover portion.

3. The optical cable stopper according to claim 1, wherein the side guide portions include second guide portions, arranged along the cut-in portions, which guide the cut-in portions by being brought into sliding contact with the side portions of the cover portion in the midst of cutting of the cover portion by the cut-in portions.

4. The optical cable stopper according to claim 1, wherein the center guide portion guides the cut-in portions by being guided into the guide groove before cutting of the cover portion by the cut-in portions.

5. The optical cable stopper according to claim 1, wherein a distal end portion of the center guide portion has a shape, a dimension of which successively reduces in a distal end direction at least in a width direction of the optical cable.

6. A fiber optic connector, including the optical cable stopper according to claim 1.

7. A vehicle, including the fiber optic connector according to claim 6.

8. An optical cable stopper that fixes an optical cable covered with a cover portion at a periphery of a fiber core line, said optical cable stopper comprising:
a plurality of cut-in portions that cut side portions of the cover portion; and
a plurality of side guide portions that guide the cut-in portions by being brought into sliding contact with the side portions of the cover portion such that the cut-in portions do not cut the fiber core line when cutting the side portions of the cover portion by the cut-in portions.

9. The optical cable stopper according to claim 8, wherein the side guide portions include first guide portions extended along distal end sides of the cut-in portions and guide the cut-in portions by being brought into sliding contact with the side portions of the cover portion before the cut-in portions cut the cover portion.

10. The optical cable stopper according to claim 8, wherein the side guide portions include second guide portions, arranged along the cut-in portions, which guide the cut-in portions by being brought into sliding contact with the side portions of the cover portion in the midst of cutting of the cover portion by the cut-in portions.

11. A fiber optic connector, including the optical cable stopper according to claim 8.

12. A vehicle, including the fiber optic connector according to claim 11.

13. An optical cable stopper that fixes an optical cable including a cover portion surrounding a plurality of fiber core lines arranged in parallel with each other at a predetermined interval therebetween, and including a guide groove provided at an outer periphery of the cover portion along a longitudinal direction of the fiber core lines at a position between two of the fiber core lines, said optical cable stopper comprising:
a plurality of cut-in portions that cut side portions of the cover portion; and
a center guide portion that guides the cut-in portions by being guided into the guide groove at the outer periphery of the cover portion and between the plurality of fiber core lines such that the cut-in portions do not cut the respective fiber core lines when cutting the side portions of the cover portion.

14. The optical cable stopper according to claim 13, wherein the center guide portion guides the cut-in portions by being guided into the guide groove before cutting of the cover portion by the cut-in portions.

15. The optical cable stopper according to claim 13, wherein the center guide portion guides the cut-in portions by piercing the cover portion between the plurality of fiber core lines from a bottom portion of the guide groove in the midst of cutting of the cover portion by the cut-in portions.

16. The optical cable stopper according to claim 13, wherein a distal end portion of the center guide portion has a shape, a dimension of which successively reduces in a distal end direction at least in a width direction of the optical cable.

17. A fiber optic connector, including the optical cable stopper according to claim 13.

18. A vehicle, including the fiber optic connector according to claim 17.
